(19) United States
(12) Patent Application Publication
(10) Pub. No.: US 2024/0060831 A1
(43) Pub. Date: Feb. 22, 2024

(54) METHOD FOR CALIBRATING A TEMPERATURE SENSOR

(71) Applicants: VITESCO TECHNOLOGIES GMBH, Regensburg (DE); CONTINENTAL AUTOMOTIVE TECHNOLOGIES GMBH, Hannover (DE)

(72) Inventors: Sébastien RAGET, TOULOUSE (FR); Florence CAPY, TOULOUSE (FR)

(21) Appl. No.: 18/028,445

(22) PCT Filed: Sep. 23, 2021
(86) PCT No.: PCT/IB21/58666

§ 371 Date: Mar. 24, 2023

(30) Foreign Application Priority Data
Sep. 24, 2020 (FR) 2009684

(51) Int. Cl. G01K 15/00

(52) U.S. Cl. CPC G01K 15/005

(57) ABSTRACT

A method, for a system (9) comprising at least one electronic component (1-3), at least one component temperature sensor (4-6) associated with said at least one electronic component (1-3) and at least one environment temperature sensor (4-7), for calibrating said at least one component temperature sensor (4-6), comprising the following steps:
before or upon starting the system (9), measuring the temperatures of said at least one component temperature sensor (4-6) and said at least one environment temperature sensor (4-7),
determining a reference temperature from the temperatures measured,
calculating, for each component temperature sensor (4-6), an offset such that the temperature measurement of the component temperature sensor (4-6), corrected by the offset, equals the reference temperature,
correcting by applying the offset to each subsequent temperature measurement.

### TECHNICAL FIELD

The invention relates to the field of electronic components and more particularly to diagnostic tools (thermal, short-circuit) integrated into such electronic components.

### PRIOR ART

It is known, in an electronic component of the type: H-bridge, ASIC, acronym for application-specific integrated circuit, or the like to integrate at least one short-circuit detection device and/or at least one temperature sensor in order to perform monitoring of the electronic component, during its operation.

One problem that arises is the absolute repeatability or accuracy of the temperature sensor(s). Indeed, such a temperature sensor is subject to large temperature amplitudes and it is difficult to guarantee the exact value of a temperature measurement. Thereby, if such a temperature measurement is used to perform a failure diagnosis, there is a risk of false detection (detection when there is no failure) or no detection (no detection when there is failure), both of which are detrimental.

### SUMMARY OF THE INVENTION

Also, the invention provides a method for calibrating temperature sensors that can be performed upon each startup of the system containing the electronic component.

For this, one object the invention is a method, for a system comprising at least one electronic component, at least one component temperature sensor associated with said at least one electronic component and at least one environment temperature sensor, for calibrating said at least one component temperature sensor, comprising the following steps: before or upon starting the system, measuring the temperatures of said at least one component temperature sensor and said at least one environment temperature sensor, determining a reference temperature from the temperatures measured, calculating, for each component temperature sensor, an offset such that the temperature measurement of the component temperature sensor, corrected by the offset, equals the reference temperature, correcting by applying the offset to each subsequent temperature measurement.

Particular characteristics or embodiments, which can be used alone or in combination, are:
the reference temperature is a statistical quantity obtained from the temperatures measured, among the mode, the average, the median or the like, preferably the mode,
a “degraded temperature sensor” alarm is issued if the absolute value of the offset is greater than a threshold, preferably equal to 15° C.,
the method further comprises the following steps, for each electronic component, a thermal model being associated with the electronic component able to estimate an estimated temperature of the electronic component as a function of a voltage and a current: starting the electronic component and measuring the voltage and current across it, determining the estimated temperature by means of the thermal model, calculating, for the electronic component, a linearity coefficient such that the temperature measurement of the component temperature sensor corrected by the offset and multiplied by the linearity coefficient equals the estimated temperature, correcting by applying the linearity coefficient to each subsequent temperature measurement,
a “degraded temperature sensor” alarm is issued if the absolute value of the linearity coefficient is greater than a threshold.

According to a second aspect of the invention, a method, for a system comprising at least one electronic component, at least one component temperature sensor associated with said at least one electronic component, at least one environment temperature sensor and at least one thermal model associated with said at least one electronic component, for thermally monitoring said at least one electronic component, comprising the following steps: calibration, regular temperature measurements by means of said at least one associated component temperature sensor, triggering of a safety shutdown of the electronic component in case a high temperature is exceeded.

According to a third aspect of the invention, a method, for a system comprising at least one electronic component, at least one component temperature sensor associated with said at least one electronic component, at least one environment temperature sensor and at least one thermal model associated with said at least one electronic component, for detecting a resistive short circuit within said at least one electronic component, comprising the following steps: calibration, regular temperature measurements by means of said at least one component temperature sensor associated, heating with a slope greater than a threshold being indicative of a resistive short circuit.

According to a fourth aspect of the invention, an ASIC comprising at least one component temperature sensor, at least one environment temperature sensor and at least one thermal model, and implementing such method.

### BRIEF DESCRIPTION OF THE DRAWINGS

The invention will be better understood upon reading the following description, made only by way of example, and with reference to the appended figures in which:

FIG. 1 illustrates an example of a system comprising three electronic components each equipped with a component temperature sensor and an environment temperature sensor,

FIG. 2 illustrates a thermal model.

### DESCRIPTION OF THE EMBODIMENTS

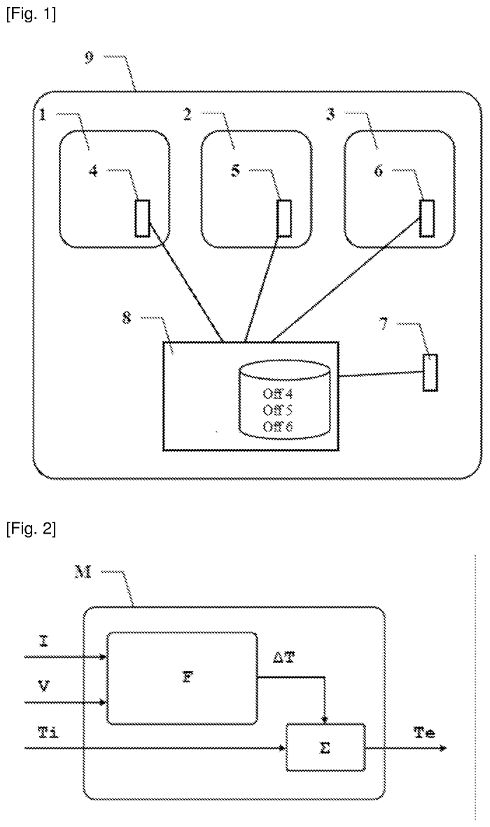

With reference to FIG. 1, a system 9 comprises at least one electronic component 1-3. Said electronic component 1-3 may be equipped with at least one temperature sensor 4-6. Said temperature sensor 4-6 may be associated with the electronic component 1-3 in that it is arranged in proximity thereto, for example on the same printed circuit board or even in a same package. Such a temperature sensor 4-6, in that it is associated with an electronic component 1-3 is called a “component” temperature sensor. One or more temperature sensors 4-6 may be associated/integrated with the same electronic component 1-3 or a single temperature sensor 4-6 may be indicative of the temperature of several electronic components 1-3, provided they share the same thermal conditions. The method of the invention requires at least two temperature sensors. Therefore, the system 9 comprises at least one additional temperature sensor 7. This additional temperature sensor is generically referred to as an “environment” temperature sensor. This environment temperature sensor may be a dedicated sensor, arranged in the system 9 without being particularly associated with an electronic component 1-3. Advantageously, a component temperature sensor 4-6, associated with another electronic component 1-3, can act as an additional temperature sensor, insofar as the system 9 comprises at least two electronic components 1-3.

The principle of the invention is that the temperature measured by a temperature sensor 4-7 is relatively accurate but may have its absolute reference and linearity vary over time. Also, the basic idea of the invention is to measure the comparative temperature of at least two temperature sensors 4-7 in a state where this temperature can be estimated.

Also, according to one characteristic of the invention, at least two temperature sensors, i.e., at least one component temperature sensor 4-6 associated with a current electronic component, and an environment temperature sensor 4-7, possibly associated with another electronic component 1-3 and the same as a component temperature sensor 4-6, mounted sufficiently close to each other, i.e., typically in a same system 9, in such a way that they measure theoretically identical temperatures, are measured in a state in which these temperatures are assumed to be at least partially known. A particular state that is readily reproduced is the state where the system 9 and all its electronic components are at rest, i.e. before their use, before start-up and before any heating.

In this state, temperature measurements of the different temperature sensors are all supposed to be identical. Therefore, all differences in measurements can be eliminated.

The only question is to determine a reference temperature Tref from the different temperatures measured. Advantageously, the reference temperature Tref is statistically the mode among the temperatures measured. The mode is the majority temperature among the temperatures measured. The mode is statistically all the better defined the more temperature sensors 4-7 are available. Also, the invention works with at least two temperature sensors 4-7, but it works better as the number of temperature sensors increases.

Thus, for example, if there are five temperature sensors 4-7, a first temperature sensor measuring a temperature T1 of 20° C., three temperature sensors measuring a temperature T2 of 22° C., and a fifth temperature sensor measuring a temperature T3 of 25° C., the mode is clearly T2 with a reference temperature Tref of 22° C., the first temperature sensor is assumed to be downwardly offset while the fifth temperature sensor is assumed to be upwardly offset.

Here the mode can be replaced by any other statistical measurement for, from the measurements of the different temperature sensors, determining a significant reference temperature Tref: average, median or the like.

The invention relates to a method, for a system 9 comprising at least one electronic component 1-3, at least one component temperature sensor 4-6 associated with said at least one electronic component 1-3 and at least one environment temperature sensor 4-7, for calibrating said at least one component temperature sensor 4-6. The method comprises the following steps:
before or upon starting the system 9, measuring the temperatures of said at least one component temperature sensor 4-6 and said at least one environment temperature sensor 4-7,
determining a reference temperature from the temperatures measured,
calculating an offset for each component temperature sensor 4-6, meaning an offset value or offset voltage in the following description, such that the temperature measurement of the component temperature sensor 4-6, corrected by the offset, equals the reference temperature,
correcting by applying the offset to each subsequent temperature measurement.

Thus, considering the previous example again, with the five temperatures T1, T2 and T3, the reference temperature Tref is here the mode and is equal to the temperature T2, that is 22° C. The first temperature sensor has an offset O1, such that T1+O1=Tref, i.e. O1=2° C. The second, third and fourth temperature sensors have a zero offset O2=O3=O4, since these sensors are already at the reference temperature. The fifth temperature sensor has an offset O5, such that T5+O5=Tref, i.e. O5=−3° C. The, each subsequent measurement is corrected by applying its offset.

Measuring the temperature, determining a reference temperature Tref, calculating the offsets O1-O5, storing and applying them to the subsequent measurements, are typically carried out by a processing unit 8 which implements the different methods.

Thus, even if the component temperature sensors 4-6 used show a drift in time, the possibility of carrying out such a calibration at each start-up makes it possible to compensate for this drift with a significant portion.

If an offset, as previously determined, is too large, i.e. greater than +/−15° C., it can be considered that the component temperature sensor 4-6 associated is failing. Thereby, in this case, a “temperature sensor” alarm, advantageously indicating the temperature sensor concerned, is issued. According to another characteristic, it can be chosen not to apply any correction for subsequent measurements in this case.

The offset is intended to correct an absolute reference error of a temperature sensor. It is further advantageous to correct a linearity error.

A thermal model M is associated with each electronic component 1-3. This thermal model M is able to estimate an estimated temperature of the electronic component 1-3 as a function of a voltage V and a current I. The model M is in the form of a function of the two variables voltage V and current I producing an estimated temperature T, according to the formula T=M (V, I). Such a model can be established theoretically or empirically.

According to one embodiment, illustrated in FIG. 2, the thermal model M comprises a function F calculating heating ΔT, as a function of the voltage V and the current I. This function depends on the type of component. The thermal model M further receives as an input the initial temperature Ti of the electronic component 1-3, typically the reference temperature. The thermal model adds heating ΔT to the initial temperature Ti to obtain the estimated temperature Te.

The thermal model M is implemented as a function, for example polynomial, recalculated for each pair V, I, in the form of a pre-calculated table, so that it can be implemented by a memory, in the form of an abacus or any other form adapted to its operational implementation.

A thermal model M can be determined for a type of component or even customized for each component individually.

Also, according to another characteristic, the calibration method may further comprise the following steps, for each electronic component 1-3. A first step is to start the electronic component 1-3 and measure the voltage V and current I across it. This is typically done by measurement means integrated into the electronic component 1-3. In their absence, for an electronic component not including such means, external measurement means can be used.

A second step consists in determining an estimated temperature, by means of the thermal model M, applied to the voltage V and current I values measured.

This estimated temperature is compared with the temperature measured by the component temperature sensor of the same electronic component 1-3, if necessary corrected by adding the offset. During a third step, a linearity coefficient associated with each electronic component 1-3 is calculated, such that the temperature measurement of the component temperature sensor 4-6 corrected by the first offset and multiplied by the linearity coefficient equals the estimated temperature.

Once this linearity coefficient is determined, all subsequent temperature measurements can be corrected by multiplicative application of the linearity coefficient.

Like the first correction by means of the offset, if the linearity coefficient is too far from unity, it can be considered that the temperature sensor component 4-6 associated is failing. Also, in this case, a “temperature sensor” alarm, advantageously indicating the temperature sensor concerned, is issued. This alarm may or may not be distinguished from the first alarm, associated with the offset. According to another characteristic, it may be chosen not to apply any further correction for subsequent measurements in this case.

The calibration described above can be applied to the thermal monitoring of at least one electronic component 1-3, provided that it is equipped with at least one component temperature sensor 4-6 and that the system 9 comprises at least one environment temperature sensor 4-7 and that a thermal model M is associated therewith. A method for thermally monitoring an electronic component 1-3 is significantly improved, robustified, if the component temperature sensors 4-6 are accurate by virtue of a calibration method, as previously described. It is thereby possible to perform regular temperature measurements by means of at least one of the component temperature sensors 4-6 thus calibrated. As the accuracy of the temperature sensor(s) component 4-6 is improved by the calibration, the accuracy of the diagnosis is equally improved. Also, a safety shutdown of the electronic component 1-3 can be triggered with greater confidence in case a high temperature is exceeded.

Similarly, a resistive short circuit detection within an electronic component 1-3 equipped with at least one component temperature sensor 4-6, having a thermal model M associated therewith and the system 9 comprising at least one environment temperature sensor 4-7, can be improved by such calibration.

Detecting a resistive short circuit is based on detecting progressive heating with a slope higher than a given threshold, typically corresponding to the self-heating of the component during its operation.

Thereby, a method for detecting a resistive short circuit comprises the steps of calibration in order to improve accuracy of the diagnosis, regular temperature measurements by means of at least one of the component temperature sensors 4-6, determining a resistive short circuit by observing heating with a slope higher than a threshold.

The invention further relates to an ASIC comprising at least one component temperature sensor 4-6, at least one environment temperature sensor 4-7 and at least one thermal model M, and implementing one of the methods for calibration, thermal monitoring and/or detection of a resistive short circuit.

The invention has been illustrated and described in detail in the drawings and the preceding description. This should be considered illustrative and given by way of example and not as limiting the invention to this description only. Many alternative embodiments are possible.

### LIST OF REFERENCE SIGNS

1-3: electronic component,
4-7: temperature sensor,
8: processing unit,
9: system,
I: current,
F: thermal function,
M: thermal model,
Tref, Ti, Te: temperature,
V: voltage.

What is claimed is:

1. A method, for a system (9) comprising at least one electronic component (1-3), at least one component temperature sensor (4-6) associated with said at least one electronic component (1-3) and at least one environment temperature sensor (4-7), for calibrating said at least one component temperature sensor (4-6), characterized in that it comprises the following steps:
before or upon starting the system (9), measuring the temperatures of said at least one component temperature sensor (4-6) and said at least one environment temperature sensor (4-7),
determining a reference temperature from the temperatures measured,
calculating, for each component temperature sensor (4-6), an offset such that the temperature measurement of the component temperature sensor (4-6), corrected by the offset, equals the reference temperature,
correcting by applying the offset to each subsequent temperature measurement.

2. The calibration method according to claim 1, wherein the reference temperature is a statistical quantity obtained from the temperatures measured.

3. The calibration method according to claim 1, wherein a “degraded temperature sensor” alarm is issued if the absolute value of the offset is greater than a threshold, preferably equal to 15° C.

4. The calibration method according to claim 1, further comprising the following steps, for each electronic component (1-3), a thermal model (M) being associated with the electronic component (1-3) able to estimate an estimated temperature of the electronic component (1-3) as a function of a voltage (V) and a current (I):
starting the electronic component (1-3) and measuring the voltage (V) and the current (I) across it,
determining the estimated temperature by means of the thermal model (M),
calculating, for the electronic component (1-3), a linearity coefficient such that the temperature measurement of the component temperature sensor (4-6) corrected by the offset and multiplied by the linearity coefficient equals the estimated temperature,
correcting by applying the linearity coefficient to each subsequent temperature measurement.

5. The calibration method according to claim 4, wherein a “degraded temperature sensor” alarm is issued if the absolute value of the linearity coefficient is greater than a threshold.

6. A method, for a system (9) comprising at least one electronic component (1-3), at least one component temperature sensor (4-6) associated with said at least one electronic component (1-3), at least one environment temperature sensor (4-7) and at least one thermal model (M) associated with said at least one electronic component (1-3), for thermally monitoring said at least one electronic component (1-3), characterized in that it comprises the following steps:
calibration according to claim 1,
regular temperature measurements by means of said at least one component temperature sensor (4-6) associated,
triggering a safety shutdown of the electronic component (1-3) in case a high temperature is exceeded.

7. A method, for a system (9) comprising at least one electronic component (1-3), at least one component temperature sensor (4-6) associated with said at least one electronic component (1-3), at least one environment temperature sensor (4-7) and at least one thermal model (M) associated with said at least one electronic component (1-3), for detecting a resistive short-circuit within said at least one electronic component (1-3), characterized in that it comprises the following steps:
calibration according to claim 1,
regular temperature measurements by means of said at least one component temperature sensor (4-6) associated,
heating with a slope higher than a threshold being indicative of a resistive short circuit.

8. An ASIC, comprising at least one component temperature sensor (4-6), at least one environment temperature sensor (4-7) and at least one thermal model (M), and implementing a method according to claim 1.
